(19) United States
(12) Patent Application Publication
(10) Pub. No.: US 2014/0123905 A1
(43) Pub. Date: May 8, 2014

(54) Push Window Aquarium

(71) Applicant: Lammert deHaan, Waxahachie, TX (US)

(72) Inventor: Lammert deHaan, Waxahachie, TX (US)

(21) Appl. No.: 13/669,185

(22) Filed: Nov. 5, 2012

(51) Int. Cl. A01K 63/00

(52) U.S. Cl. 119/265; 119/269

(57) ABSTRACT

The present invention is an aquarium system in which the interior of the aquarium may be accessed through a push window. The aquarium window allows for expeditious access to the interior of the aquarium without the burden of dealing with an aquarium lid or cover. To expose the interior of the aquarium, the user pushes the top portion of the from panel and then lifts the bottom portion of the front panel. Users may access the aquarium interior without removing, and temporarily storing, a heavy and burdensome aquarium lid or cover. This less arduous system provides access to the aquarium's interior allowing for faster cleaning and feeding of aquatic life. The aquarium system also fosters increased humidity to encourage tropical plant growth within the aquarium system and provides natural pond like views to observers.

### CROSS-REFERENCE TO RELATED APPLICATIONS

None

### TECHNICAL FIELD

This invention relates to an aquarium with a push window, which allows for more convenient access to the interior portion of the aquarium.

### DESCRIPTION OF PRIOR ART

An aquarium is a container used to store water dwelling plants and/or animals. The aquarium is commonly used to keep fish, turtles and aquatic plants. Aquarium sizes range from a small bowl to large wall units that are the length of walls inside residential homes. Aquariums are commonly constructed of glass or acrylic plastic sealed with silicone or another material.

Due to the accumulation of fish waste, uneaten food, and various other products of aquatic life, the water within the aquarium can become quite dirty and toxic for the aquatic life living in the aquarium. In order to clean the aquarium, the owner must remove the heavy and oftentimes bulky lid, hood or cover. The user also must remove the bulky cover in order to feed the creatures, change the light source, or to clean the pump and/or decorative items in the aquarium.

As the aquariums increase in size, the lids or hoods also increase in size, which contributes to the difficulty in removing the lid for regularly scheduled maintenance or cleaning, daily feedings, or the occasional aquarium repair. If the aquarium is covered by a hood, then the removal is even more cumbersome since a hood is larger than a flat lid covering. The hood removal is also more difficult as the tank increases in size. One the work is done inside the aquarium, the lid or hood has to be replaced. If the user has a large tank, one or more additional people will be required to reposition the hood on top of the aquarium. In fact, this chore may be so burdensome that a tank owner will feel compelled to hire a professional to deal with the voluminous tank.

Once the lid or hood has been removed, it has to be stored until the interior of the tank is cleaned or repaired. Storage of the lid could create moisture deposits wherever the lid is stored. In the case of carpet or wood flooring, the moisture could cause damage to the surface. In addition, the lid is in danger of being broken or damaged while it is detached from the aquarium.

The present invention eliminates the usual hassle involved in removing the lid or cover to change the water, dean the tank, feed the fish or change the light bulb by use of a push window device. With a swift motion of the hand, the user can push and lift the aquarium window to expose the interior of the aquarium.

### OBJECTS OF THE INVENTION

An object of the present invention is to allow the user to access the interior of the aquarium without detaching a large and cumbersome lid or hood piece.

Another object of the present invention is to allow the user to quickly and conveniently access the interior of the aquarium unit for cleaning, feeding or other maintenance activities, without lifting the typical heavy and difficult to remove aquarium lid or cover.

Another object of the present invention is to provide an unobstructed pond like view of the interior of the aquarium.

Another object of the present invention is to provide a desirably high humidity level within the aquarium optimize tropical plant growth.

### SUMMARY OF THE INVENTION

The present invention is an aquarium that includes a push and lift window component that allows easier access to the interior of the aquarium. Users gain access to the interior of the aquarium by pushing the top of the window backward and lifting the bottom of the window with a series of swift movements. Users are able to quickly access the interior of the aquarium for cleaning, feeding, and other general maintenance activities. Once a user gently pushes and lifts the front window of the aquarium, the front window will rise, exposing the interior of the aquarium. When the front window is pushed fully open, the front window rests beneath the top panel of the aquarium. In order to close the aquarium, the user would gently pull down on the bottom portion of the front window. The aquarium includes at least two stopper pegs, protruding inward from the side walls of the aquarium, that function to stop the movement of the front window as the front window is repositioned from an open to a closed state.

The frame of the aquarium is mainly constructed of multiple panels of varying sizes. In this embodiment, the panels are constructed from glass but may be constructed of materials with similar qualities. The glass panels include a front lower panel perpendicular to the base, a sloped front upper panel which comprises the push window portion of the aquarium, two side (left and right) panels which each have five sides included a sloped edge to accommodate the push window, a rear panel, a top panel, and a base panel.

The top panel of the aquarium is attached to the two side panels, the rear panel and front sloping panel. When the push window is raised, it slides directly beneath the top panel of the aquarium. The top panel is also surrounded by a plastic protective edge, which serves to guard the edges and corners of the aquarium. The protective edge protects the sealed joints and corners of the aquarium device and also protects the corners from wear and tear from daily use.

Various embodiments may include one or more of the following features. The aquarium may also include a combination ledge and waterfall on the interior of the rear wall of the aquarium. The ledge/waterfall section may be composed of rock, stone, brick, marble, or plastic. This area provides a resting area for aquatic life as well as tropical plants. It also fosters the growth of algae, which are beneficial to the aquarium environment. The structure of the aquarium also fosters a humid environment above the water level. The sloping window traps moisture above the water level in the aquarium which creates an optimal environment for tropical plants to flourish. The unique construction of the aquarium allows for multiple views of the interior such that the experience is more akin to the observation of a pond or other natural aquatic habitat. The views into the aquarium from both sides as well as from the front and the sloped front push window create a unique opportunity to serve the interior of the aquarium. In prior art designs, the view has been obstructed by hinges or sliding window rails. The construction of the push window also ensures that a cat or other curious creature does not gain access to the interior while also ensuring that the aquatic creatures are secure within the aquarium.

In this embodiment, the aquarium is stored on a stand that includes a top portion which is a platform for the base of the aquarium. The stand includes a ledge that surrounds the aquarium base and helps to secure the aquarium in the aquarium stand. The stand is supported by four legs that run from the base to the ground or whatever surface the entire aquarium rests on. The stand also includes a back support portion that runs from the ledge of the stand to the top of the aquarium. The back support offers additional stability to the aquarium system resting on the stand. The back support serves to prevent the aquarium system from toppling or falling from the stand.

The selection of the particular features described above determines the advantages of the present invention for the user. The present invention improves upon the traditional aquarium system since it allows convenient and manageable access to the interior of the aquarium through a push window device. Anytime that the user desires to access the interior of the aquarium, the user simply has to push and lift the window. The window will stay raised until the user is finished with the task and decides to lower the window with a series of swift and uncomplicated motions. In addition, this aquarium provides unique pond-like views of the interior area and a high humidity level above the water surface that is beneficial for tropical plants.

### BRIEF DESCRIPTION OF THE DRAWINGS

FIG. 1 is a front view of the closed push window aquarium;

Ref. 1 is a view of the bottom base panel of the aquarium;

Ref. 2 is a view of the front lower panel of the aquarium;

Ref. 3 is a view of the front upper panel or push window of the aquarium;

Ref. 4 is a view of the rear panel of the aquarium;

Ref. 5 is a view of the stopper peg on the side of the aquarium;

FIG. 2 is a partial side view of the closed aquarium;

Ref. 1 is a view of the bottom base panel of the aquarium;

Ref. 2 is a view of the front lower panel of the aquarium;

Ref. 3 is a view of the front upper panel or push window of the aquarium;

Ref. 5 is a view of the stopper peg on the side of the aquarium;

Ref. 6 is a view of the left side panel of the aquarium;

Ref. 7 is a view of the right side panel of the aquarium;

Ref. 9 is a view of the optional decorative cover for the aquarium;

Ref. 10 is a view of the optional lighting device for the aquarium;

Ref. 11 is a view of the optional decorative stand for the aquarium;

FIG. 3 is partial side view of the partially open aquarium being pushed by the user;

Ref. 2 is a view of the front lower panel of the aquarium;

Ref. 3 is a view of the front upper panel or push window of the aquarium;

Ref. 5 is a view of the stopper peg on a side of the aquarium;

Ref. 6 is a view of the left side panel of the aquarium;

Ref. 7 is a view of the right side panel of the aquarium;

Ref. 12 is a view of the user's hand pushing the front panel or push window of the aquarium;

FIG. 4 is a partial side view of the partially open aquarium being lifted by the user;

Ref. 2 is a view of the front lower panel of the aquarium;

Ref. 3 is a view of the front upper panel or push window of the aquarium;

Ref. 5 is a view of the stopper peg on a side wall of the aquarium;

Ref. 6 is a view of the left side panel of the aquarium;

Ref. 7 is a view of the right side panel of the aquarium;

Ref. 12 is a view of the user's hand lifting the front panel or push window of the aquarium;

FIG. 5 is a partial side view of the fully open aquarium being lifted by the user;

Ref. 2 is a view of the front lower panel of the aquarium;

Ref. 3 is a view of the front upper panel or push window of the aquarium in an open position;

Ref. 5 is a view of the stopper peg on a side wall of the aquarium;

Ref. 6 is a view of the left side panel of the aquarium;

Ref. 7 is a view of the right side panel of the aquarium;

Ref. 12 is a view of the user's hand lifting the front panel or push window of the aquarium;

FIG. 6 is a full side view of the fully open aquarium in a state of rest;

Ref. 1 is a view of the bottom base panel of the aquarium;

Ref. 2 is a view of the front lower panel, of the aquarium;

Ref. 3 is a view of the front upper panel or push window of the aquarium in an open position;

Ref. 4 is a view of the rear panel of the aquarium;

Ref. 6 is a view of the left side panel of the aquarium;

FIG. 7 is a top view of the partially open aquarium;

Ref. 2 is a view of the front lower panel of the aquarium;

Ref. 3 is a view of the front upper panel or push window of the aquarium in an open position;

Ref. 4 is a view of the rear panel of the aquarium;

Ref. 5 is a view of the stopper peg on a side wall of the aquarium;

Ref. 6 is a view of the left side panel of the aquarium,

Ref. 7 is a view of the right side panel of the aquarium;

Ref. 8 is a view of the top cover panel of the aquarium.

### DETAILED DESCRIPTION

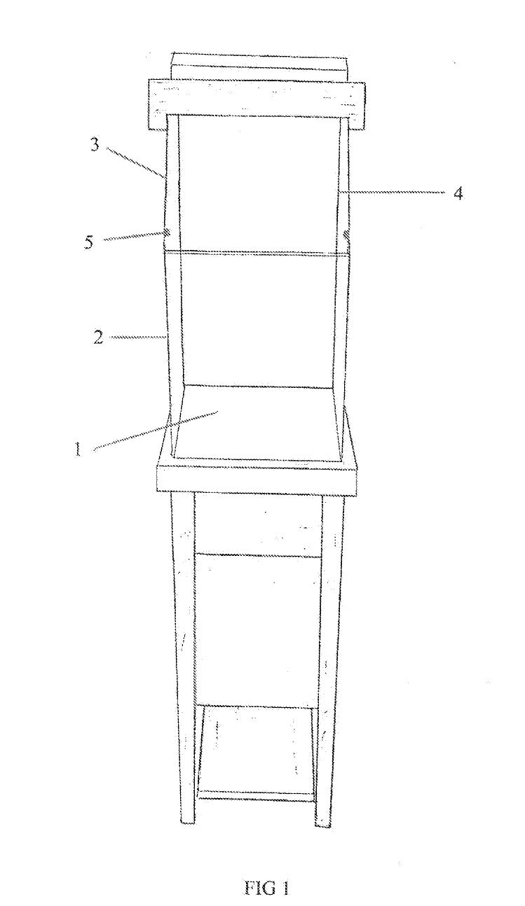

The present invention is an aquarium system with a push and lift window (3) for quick access to the interior of the aquarium system. FIG. 1 is a front view of the aquarium system. The front lower panel (2) is rectangular shaped. Positioned perpendicular to the left and right sides of the front lower panel are the left side panel (6) and right side panel (7) of glass. The sides of the left side panel (6) and right side panel (7) adjoining the front lower panel (2) are of equal length. The bottom edge of the front upper panel (3) meets the top edge of the front lower panel (2) although these two pieces are not permanently joined together. The left side of the front upper panel (3) rests adjacent to the upper portion of the left side panel (6) and right side of the front upper panel (3) rests adjacent to the upper portion of the right side panel (7) although these two pieces are not permanently joined together. These longer top edges of the left side panel and right side panel are sloped to accommodate the front upper panel, or push window (3) of the invention. In a closed position, the push and lift window (3) rests on stopper pegs (5) embedded on the interior of the side panels: the lower end of the sloped side of the left side panel (6) and the lower end of the sloped side of the right side panel (7). The left side of the rear panel (4) is attached to the back edge of the left side panel (6) and the right side of the rear panel (4) is attached to the back edge of the right side panel (7). The back edge of the left side panels and the back edge of the right side panels are the longest sides of the five sided side panels. The shortest edge of the left side panels (6) and right side panel (7) is connected to the top panel cover (8).

The left side panel (6) and right side panel (7) each has five sides. The front of the left side panel and front of the right side panel are both adjoined to the left side of the front lower panel (2) and the right side of the front lower panel (2). The bottom of the left side panel (6) is adjoined to the left side of the base (1) of the aquarium. The bottom of the right side panel (7) is adjoined to the right side of the base (1) of the aquarium. The rear of the left side panel (6) is adjoined to the left side of the rear panel (4) and the rear of the right side panel (7) is adjoined to right side of the rear panel (4). The short top of the left side panel (6) is adjoined to the left side of the aquarium top panel, which is positioned beneath the optional lighting fixture (10) and aquarium decorative cover (9). The short top of the right side panel (7) is adjoined to the right side of the aquarium top panel (8), which is positioned beneath the lighting fixture (10) and aquarium decorative cover (9). The long sloping side of the left side panel (6) is positioned adjacent to, but not permanently adjoined, the left side of the front upper sliding panel (3). The long sloping side of the right side panel (7) is positioned adjacent to, but not permanently adjoined, the right side of the front upper sliding panel (3).

FIG. 1 is a front view of the closed aquarium system, which includes a push and lift window (3) to access the interior of the aquarium. The push and lift window is also the front upper panel (3) of the aquarium. When in a position of rest, the front upper panel (3) rests on dual stopper pegs (5). The aquarium consists of four walls with a top (8), a base (1) and a sloped front upper panel (3). The four aquarium wails consist of a front lower panel (2), a rear panel (4) and dual side panels (a left side panel and a right side panel). This particular embodiment is shown with a decorative stand (11) that includes a decorative cover (9) and lighting fixture (10).

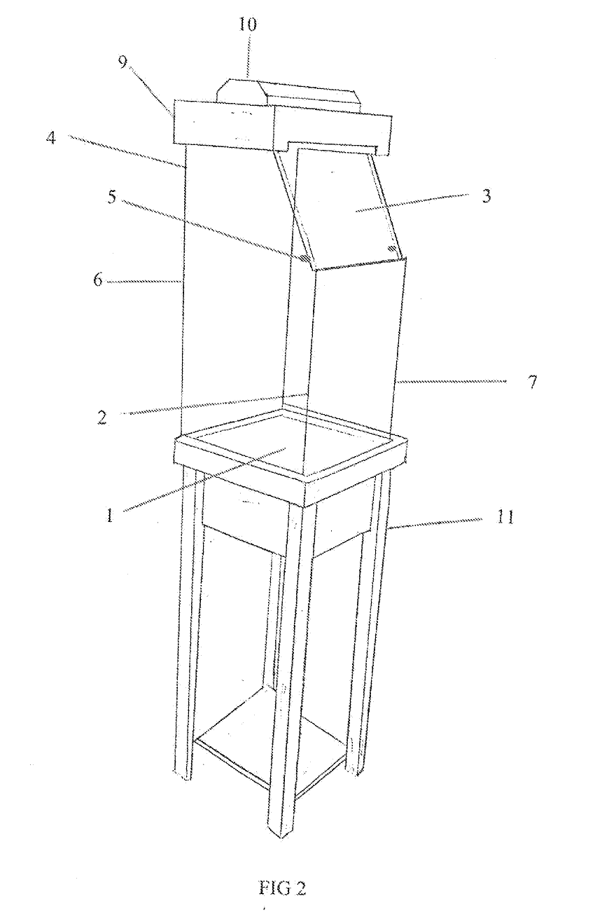

FIG. 2 is a side view of the closed aquarium system. The aquarium consists of four walls with a top (8), a base (1) and a sloped front upper panel (3). The four aquarium walls consist of a front lower panel (2), a rear panel (4) and dual side panels including a left side panel (6) and a right side panel (7). The closed front upper panel (3) rests on dual stopper pegs (5) when in a closed position. This particular embodiment is shown with a decorative stand (11) that includes a decorative cover (9) and lighting fixture (10).

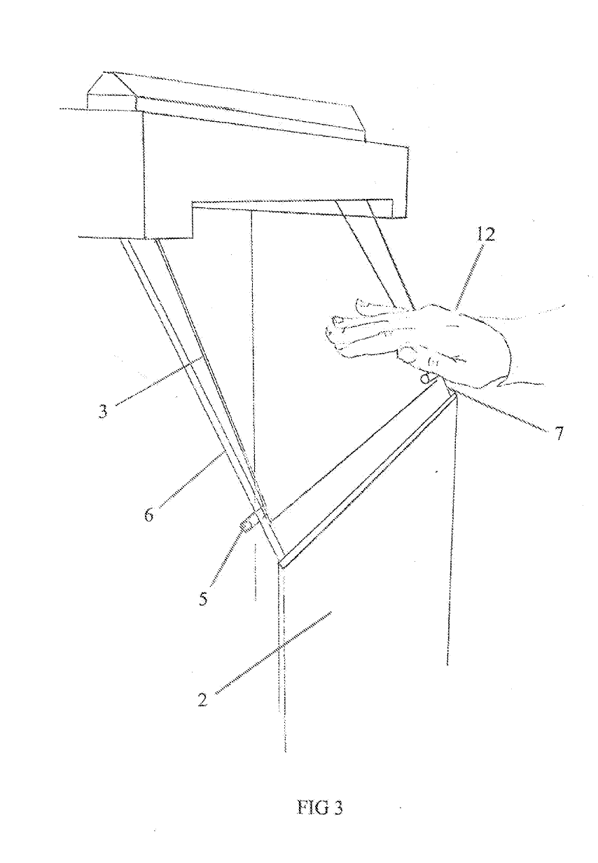

FIG. 3 is a side view of the partially open push and lift window (3) which has been pushed by the user's hand (12) in order to raise the bottom edge of the front upper panel (3) away from the stopper pegs (5). Once the front upper panel (3) is raised by a slight push, the edge of the front upper panel (3) is no longer in contact with the top edge of the front lower panel (2). The left stopper peg (5) is positioned on the interior of the left side panel (6) and the right stopper peg (5) is positioned on the interior of the right side panel (7).

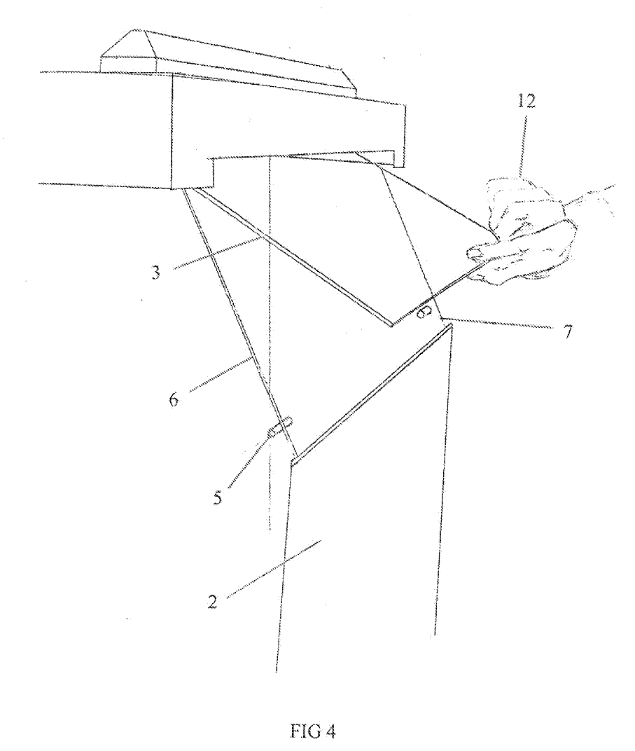

FIG. 4 is a side view of the partially open push and lift window (3) being lifted by the user's hand (12) in order to continue raising the bottom edge of the front upper panel (3) away from the stopper pegs (5). The front edge of the kit side panel (6) is adjoined to the back left side of the front lower panel (2) and the front edge of the right side panel (7) is adjoined to the back right side of the front lower panel (2). The connections between the side panels and the front lower panel are permanent in order to secure water within the aquarium system.

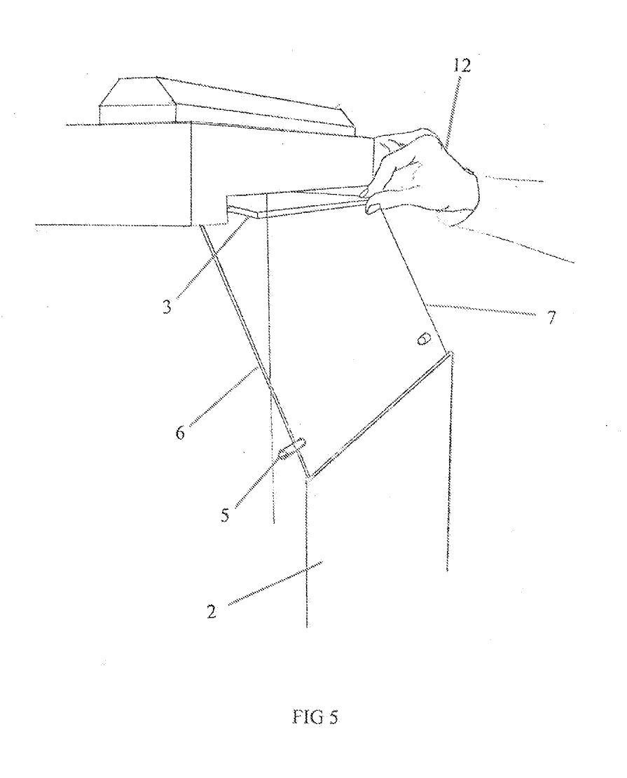

FIG. 5 is a side view of the fully open push and lift window (3) as the user (12) completes the motion of lifting the front upper panel (3). At this point, the front upper panel (3) is parallel to and positioned beneath the top panel (8). The front upper panel is no longer adjacent to the front lower panel (2) nor does the front upper panel (3) rest on the stopper peg (5) in an open position. The interior side of the top panel (8) lies adjacent to the top straight edges of the left side panel (6) and the right side panel (7) when the push and lift window (3) is in a fully open position.

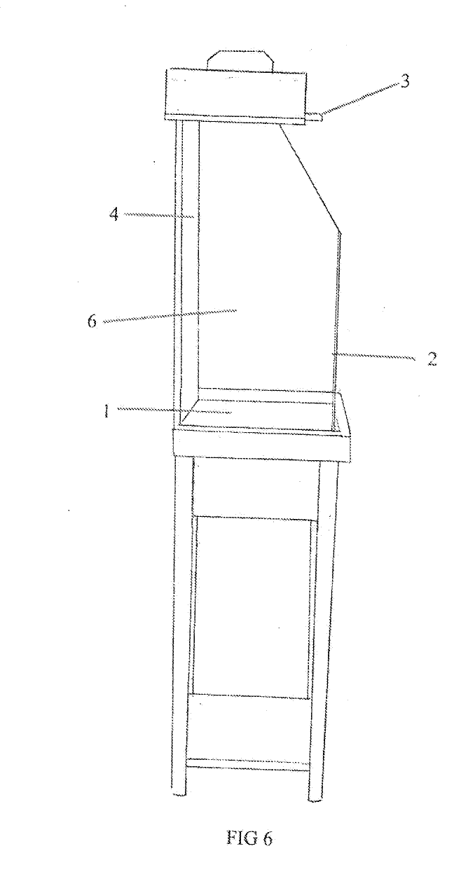

FIG. 6 is a side view of the fully open push and lift window (3). In this position, the interior of the aquarium system is easily accessible by the user for cleaning, maintenance or any number of activities related to the care and upkeep of an aquarium. The aquarium consists of four walls in addition to a top cover (8), a base (1) and a front upper panel (3), which rests beneath the top cover panel (8) when the push and lift window (3) is fully open. The four aquarium walls consist of a front lower panel (2), a rear panel (4), a left side panel (6) and a right side panel.

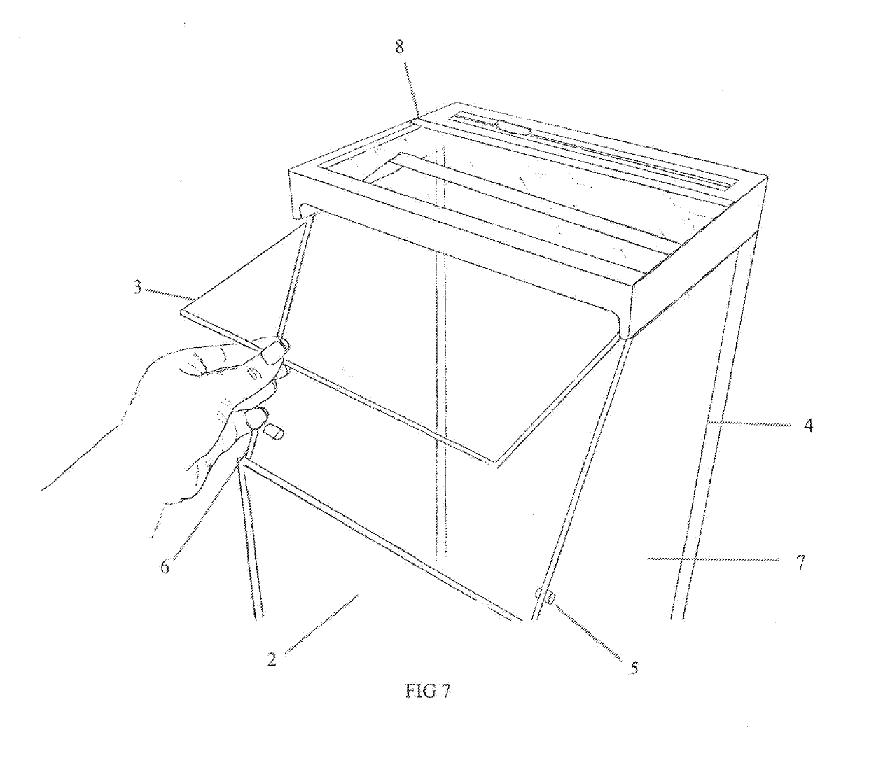

FIG. 7 is a top view of the push and lift window (4) in a partially open state. As the user (6) continues to lift the front upper panel (4), the front upper panel moves further away from the stopper peg (5) and the top edge of the front lower panel (2) and slides further beneath the top cover panel (8). When the front upper panel (4) is fully open, it lies parallel to and beneath the top cover panel (8). The left side of the top cover panel (8) is connected to the top straight edge of the left side panel (3) and the right side of the top cover panel (8) is connected to the top straight edge of the right side panel (7).

1. An aquarium comprising:
a structure;
a base panel;
a cover panel; and
push window.

2. The aquarium of claim 1, wherein said structure is comprised of a front wall, a rear wall, a left side wall, and a right side wall.

3. The aquarium of claim 2, wherein said front wall of said structure is of shorter length than said rear wall of said structure.

4. The aquarium of claim 3, wherein said front wall of said structure is of shorter length than both said left wall and said right wall of said structure.

5. The aquarium of claim 4, wherein said base panel is permanently positioned beneath a lower portion of said front wail, said rear wall, said left wall and said right wall of said structure.

6. The aquarium of claim 5, wherein said cover panel is permanently positioned above an upper portion of said front wall, said rear wall, said left wall and said right wall of said structure.

7. The aquarium of claim 6, wherein said push window is positioned at an angle between said cover panel and said front wall.

8. The aquarium of claim 7, wherein the interior of said aquarium is accessed by pushing backward on an upper portion of said push window such that said upper portion of said push window glides beneath said cover panel.

9. An aquarium comprising: a structure, a base panel, a cover panel, and a push window; wherein said structure is comprised of a front wall, a rear wall, a left side wall, and a right side wall; wherein said front wall of said structure is of shorter length than said rear wall, of said structure; wherein said base panel is permanently positioned beneath a lower portion of said front wall, said rear wall, said left wall, and said right wall of said structure; wherein said cover panel is permanently positioned above an upper portion of said front wall, said rear wall, said left wall, and said right wall of said structure; wherein said push window is positioned at an angle between said cover panel and said front wall; wherein the interior of said aquarium is accessed by pushing backward on an upper portion of said push window such that said upper portion of said push window glides beneath said cover panel; wherein said push window is secured in an open state when a user pushes backward on said upper portion of said push window such that said upper portion of said push window glides beneath said cover panel, wherein said user lifts a lower portion of said push window, such that said lower portion of said push window rises upward, wherein the entire push window slides into a resting position beneath and parallel to said cover panel.

10. The aquarium of claim 9, wherein, in an open position, an upper exterior edge of said push window is positioned adjacent to said rear wall and a length of said push window rests parallel to and beneath said cover panel such that the interior of said aquarium, is open to an outside environment.

11. The aquarium of claim 9, wherein, in a closed position, a lower exterior edge of said push window rests adjacent to a top edge of said front wall, wherein at least one lower, outer edges of said push window rests upon at least one peg; said peg located on top forward portions of each of said left side wall and said right side wall; wherein an upper exterior edge of said push window rests beneath said cover panel such that said aquarium is closed to the outside environment.
